(19) United States
(12) Patent Application Publication
(10) Pub. No.: US 2010/0199223 A1
(43) Pub. Date: Aug. 5, 2010

(54) HIERARCHY DISPLAY

(75) Inventor: Scott Colner, Portland, OR (US)

Correspondence Address: Squire, Sanders & Dempsey L.L.P.;Oracle International Corporation, 8000 Towers Crescent Drive, 14th Floor, Vienna, VA, 22182, US

(73) Assignee: Oracle International Corporation, Redwood Shores, CA (US)

(21) Appl. No.: 12/364,629

(22) Filed: Feb. 3, 2009

(51) Int. Cl. G06F 3/048

(52) U.S. Cl. 715/853

(57) ABSTRACT

A method for establishing a hierarchy display includes identifying a basis for a hierarchy. A root of a data set is determined using the basis. A hierarchy is configured beginning at the root. The hierarchy is populated with selected values from the data set. Supplemental data is generated based on the selected values. The hierarchy is embedded with the supplemental data. The resulting hierarchy is displayed.

### FIELD OF THE INVENTION

One embodiment is directed generally to a computer system, and in particular to a system for configuring a hierarchy display.

### BACKGROUND INFORMATION

Many systems utilize tables to organize data. A table consists of an ordered arrangement of columns and rows. When data is randomly entered into a table, the resulting table structure provides a limited view of any relationships that may exist among data.

As an example, financial systems often rely upon a table or a spreadsheet that includes numerical data. In many instances, a particular data record may be related to at least one other data record. However, when these data records are within random positions of a data table, a user may have a difficult time visualizing the multi-level relationships, which may exist, because the basic table format provides only two levels of detail. For example, a particular data record within a table structure may include information identifying a related data record within a field of the data record itself. This presentation is limiting, especially for data sets that may contain a number of multi-level relationships.

### SUMMARY

One embodiment is a method for establishing a hierarchy display, which includes identifying a basis for a hierarchy. A root of a data set is determined using the basis. A hierarchy is configured beginning at the root. The hierarchy is populated with selected values from the data set. Supplemental data is generated based on the selected values. The hierarchy is embedded with the supplemental data. The resulting hierarchy is displayed.

### BRIEF DESCRIPTION OF THE DRAWINGS

FIG. 1 is a diagram of a data set that a system may access to configure a hierarchy display in accordance with one embodiment.

FIG. 2 is a diagram illustrating a hierarchy display with respect to the exemplary data shown in FIG. 1 in accordance with one embodiment.

FIGS. 3A and 3B are diagrams illustrating an enlarged view of a node of FIG. 2 in accordance with one embodiment.

FIG. 4 is a block diagram of a system that is configured to implement one embodiment.

FIG. 5 is a flow diagram illustrating a method of creating a hierarchy display in accordance with one embodiment.

FIG. 6 is a flow diagram illustrating a method of determining a root of a hierarchy in accordance with one embodiment.

FIGS. 7A and 7B are flow diagrams illustrating a method of populating a hierarchy in accordance with one embodiment.

FIG. 8 is a flow diagram illustrating a method of generating supplemental data and populating a hierarchy with the supplemental data in accordance with one embodiment.

### DETAILED DESCRIPTION

One embodiment is a system that creates a hierarchy display based on a structure having data with multi-level relationships. The system does not modify this existing structure, or the data contained in the structure. Instead, the system utilizes this structure to create a hierarchy display based on information retrieved from the structure. In addition, the system is configured to analyze at least one component of the hierarchy and provide supplemental data, which provides further analytical information regarding data, which is selected to populate the hierarchy display. The supplemental data may populate the hierarchy.

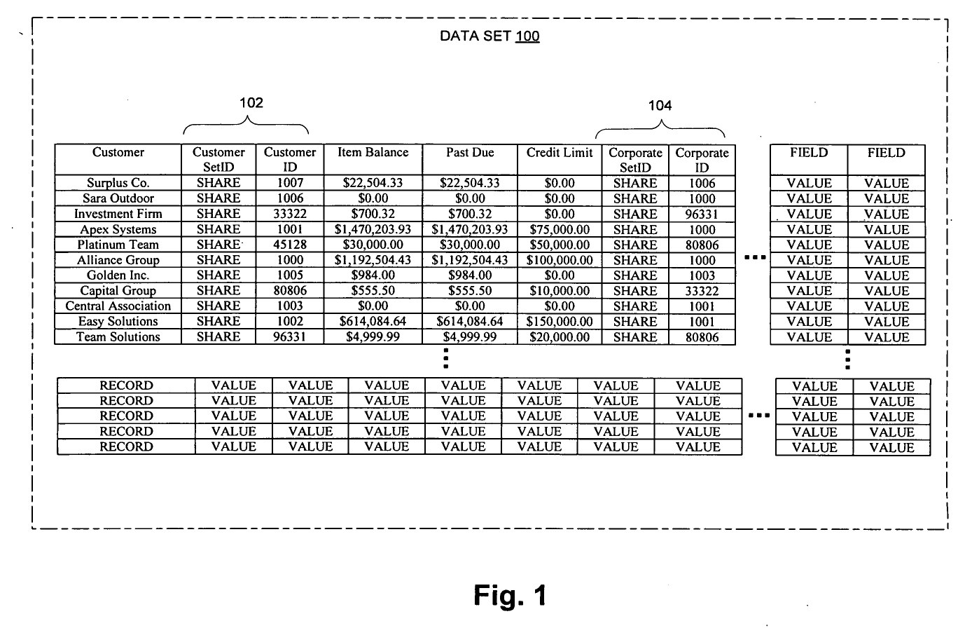

FIG. 1 illustrates an example of a data set. In this simplified example, FIG. 1 illustrates the data set 100 as being stored and organized in a table, containing a number of rows and columns. Each row may represent a data record. Each column may represent a data field of the data record. Each data field, which populates a given row, contains information associated with that particular data record.

Data set 100 may contain any type of data. However, each data record must include a key, uniquely identifying the data record, and at least one relationship key. Keys are used to identify an entity of information, such as a specific data record, unambiguously. Keys, generally, refer to a minimal set of columns that contain a different combination of values for each row of a table. Relationship keys, generally, identify related entities.

For example, in FIG. 1, data set 100 is a receivables collections workbench page. The receivables collections workbench page may include a number of entities (e.g., Customers) and their associated data. For example, each entity in data set 100 includes a key 102 (e.g., Customer SetID and Customer ID) that uniquely identifies each customer. Data set 100 may include a number of relationship keys. FIG. 1 displays only one of the relationship keys, specifying a corporate parent of a customer. In this case, the relationship key is a parent key 104 (e.g., Corporate SetID and Corporate ID). A parent key identifies a parent of an entity, if one exists. Each entity in the data set 100 may further include an alias (e.g., Customer Name), which may be used to identify a data record by name. In FIG. 1, each entity is associated with financial data, which includes an Item Balance, Past Due Balance, and Credit Limit.

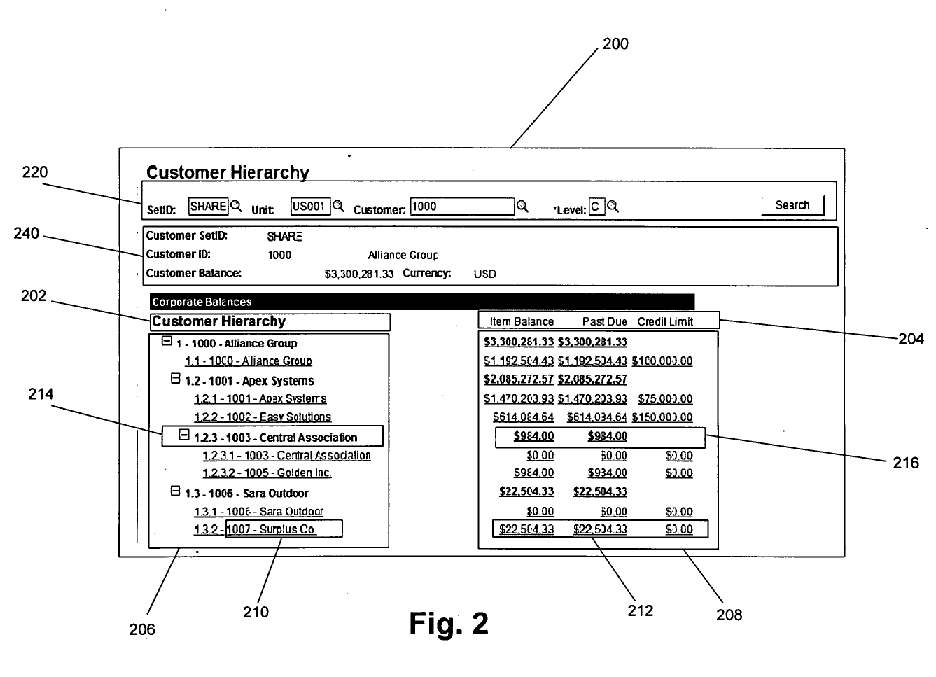

FIG. 2 illustrates a hierarchy display 200 in accordance with one embodiment that is generated based in part, on values selected from data set 100 shown in FIG. 1. Hierarchy display 200 includes a search tool 220 that allows a user to specify a particular basis, focus, or foundation for the hierarchy. In this example, search tool 220 includes a number of search fields associated with identifying the hierarchy basis.

For example, “Level: C” is a search field, which indicates the particular data set and relationship key that the hierarchy should be based upon. In FIG. 2, “Level C” indicates that hierarchy display 200 should be based on the corporate hierarchy, corresponding to relationship key 104 of data set 100. In this example, each data record in data set 100 may include a number of relationship keys. Each of the relationship keys may relate the data record to a particular hierarchy, such as a corporate hierarchy (as shown in FIG. 2), a “remit from” hierarchy, and a correspondence hierarchy. Accordingly, if data set 100 includes a number of relationship keys for each data record, then including a search tool 220 that has this type of information allows an entity to configure a hierarchy based on the desired relationship key.

Search tool 220 may include a SETID, a Unit, and a Customer ID, as search fields. Each search field provides information regarding the hierarchy basis. To receive a hierarchy display, each search field should include a value found in data set 100. The user may thus receive a hierarchy display 200 upon inputting or selecting data with search tool 220. This feature allows a user to instantaneously search and view a hierarchical display for any entity based on selected fields of data set 100.

In an alternative embodiment, instead of specifying the hierarchy basis through search tool 220, the hierarchy basis may be specified in accordance with a Role Based Access Control (RBAC) system. For example, upon recognizing a user and his/her role, the RBAC system may specify the hierarchy basis, which the user is authorized to access.

Hierarchy display 200 further includes a header 240. Header 240 may include any relevant information regarding the current hierarchy display. The relevant information may include the particular focus (e.g., basis) of the current hierarchy being displayed, as well as any analytical information. The analytical information may further supplement and/or summarize the actual information that is contained in hierarchy display 200. In the example of FIG. 2, header 240 includes the Customer Balance for the current hierarchy basis, which was specified and requested via search tool 220. The Customer Balance is a summation of the current hierarchy basis and all of its related entities (e.g., children).

Hierarchy display 200 includes a hierarchical grid (“H-Grid”) including section 206 and section 208. Section 206 and section 208 include values, which are selected and retrieved from data set 100. Hierarchy display 200 may include a title 202 for section 206 and a title 204 for section 208. Title 202 and/or title 204 may be retrieved from data set 100, or may be customized. H-Grid titles 202 and 204 provide labels that describe the data that populates section 206 and section 208, respectively.

Section 206 is populated with identifiers. An identifier 210 identifies a particular member (e.g., Customer) of the hierarchy display. Identifier 210 may include a link, which provides direct access to other related information. In FIG. 2, identifier 210 includes values associated with the following fields: Customer ID and Customer Name. As shown in FIG. 2, the identifier includes a single link, which provides direct access to general information regarding the customer, identified by the identifier. An entity may specify the number of identifiers, which will be shown in the hierarchy display 200.

Section 208 is populated with data 212, associated with each identifier (i.e., member) of the hierarchy. Data 212 may include a link, which provides direct access to other related information. In FIG. 2, data 212 includes values associated with the following fields: Item Balance, Past Due, and Credit Limit. In section 208, each Item Balance value includes a link to information relating to purchases, which contributed to the Item Balance value. Each Past Due value includes a link to information relating to items, which are past due. Each Credit Limit value includes a link to information regarding a customer's credit limit. In general, for every identifier 210, there is corresponding data 212. An entity may specify a number of fields for data 212, which will be shown in hierarchy display 200.

A number of identifiers 210 and corresponding data 212 may collectively form a logical grouping, referred to as a “node.” Hierarchy display 200 includes a number of nodes. A node may be created for each member that has a sibling and children. Each member that has siblings and no children will be displayed at the same level, and will be a part of a node, but will not be represented as a node itself. Each node includes a node identifier 214 and a node summary 216, which may be emphasized in comparison to other node elements, for example, by being displayed in bold font. For example, hierarchy display 200 includes a node identifier 214 (e.g., “1.2.3-1003-Central Association”), and a node summary 216 (e.g., “$984.00 $984.00”).

Node identifier 214 and node summary 216 may be generated based on an analysis of the hierarchy and/or its components. Node identifier 214 identifies a particular node member. In FIG. 2, a node is created for every parent member, and the node identifier 214 takes the name of the first listed identifier of a level or the first listed sibling of the hierarchy. Node identifier 214 may be configured to include a customer count for the node. For example, when populated with a customer count, node identifier 214 would be “1.3-1006-Sara Outdoor (2)” to indicate that the “Sarah Outdoor” node contains two hierarchy members.

Node summary 216 may provide supplemental data, which may include an analysis of a component, such as a branch. In FIG. 2, node summary 216 provides a summation of values, associated with all hierarchy members contained in a branch. For example, Apex Systems node includes a node summary 216 for “Item Balance,” containing a value of $2,085,272.57, which is a summation of the Item Balances for Apex Systems ($1,470,203.93), Easy Solutions ($614,084.64), and Central Association ($984.00). As another example, the node summary 216 for the Past Due of Alliance Group is $3,300,281.33, which is a summation of the Past Due for Alliance Group ($1,192,504.43), Apex Systems ($2,085,272.57) and Sara Outdoor ($22,504.33).

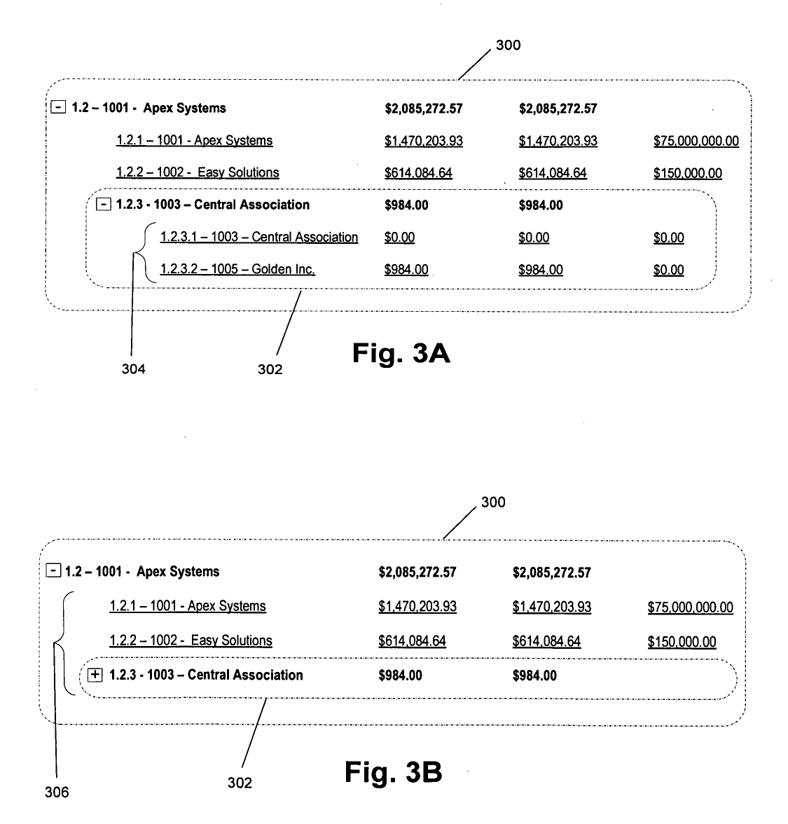

A branch contains a number of hierarchy members of the same level. A node may include a branch having a hierarchy member in which the hierarchy member itself is a node. In other words, a node may include a number of subnodes. A subnode, generally, refers to a node that is nested within another node. Exemplary illustrations of nodes and their components can be found in FIGS. 3A and 3B.

FIGS. 3A and 3B illustrate enlarged views of an “Apex Systems” node 300, taken from hierarchy display 200 shown in FIG. 2. FIG. 3A illustrates an “Apex Systems” node 300 in expanded form, and a “Central Association” node 302 in expanded form. FIG. 3B illustrates the “Apex Systems” node 300, which contains a “Central Association” node 302 in collapsed form.

In this example, Central Association node 302 is considered to be a subnode of the Apex Systems node 300. As illustrated in FIG. 3A, Central Association node 302 includes a branch 304, which includes two hierarchical members: (1) Central Association; and (2) Golden Inc. As illustrated in FIG. 3B, Apex Systems node includes a branch 306, which includes three hierarchical members: (1) Apex Systems; (2) Easy Solutions; and (3) Central Association.

As illustrated in FIGS. 2, 3A, and 3B, each node is collapsible and/or expandable, as denoted by the (+)/(−) icon. Whether in collapsed or expanded form, node identifier 214 and node summary 216 are able to provide detailed information (e.g., collective analytical information) regarding a particular member of the hierarchy, as well as information concerning its relation to other members of the hierarchy. In collapsed form, node identifier 214 and node summary 216 are the main attributes of the node that are visible. These features enable the user to obtain an overall sense of a node without having to view each item of information, which is contained in the node. In expanded form, each node includes a complete listing of selected values from data set 100 corresponding to members of the same hierarchical level and any associated children.

Hierarchy display 200 may be set up such that the hierarchy is initially expanded only for the branch of the hierarchy basis, which is specified via search tool 220, and collapsed for all other branches. In addition, hierarchy display 200 may be set up such that the member, associated with the hierarchy basis, is color coded, emphasized, or highlighted in some manner in comparison to other members of the hierarchy.

To facilitate in navigating and determining a position of a member of the hierarchy, hierarchy display 200 may include a numbering system, such as “1, 1.1, 1.2, 1.2.1, 1.2.2, 1.2.3, 1.2.3.1, 1.2.3.2, 1.3, 1.3.1, and 1.3.2,” as shown in FIG. 2. The numbering system may be displayed anywhere. In FIG. 2, the numbering system is displayed in association with the identifiers.

In general, the numbering system assigns numbers to different items based on a scheme, or a set of rules. In this case, the numbering system denotes each identifier's position within the hierarchy. In FIG. 2, each member in the hierarchy is a customer with its own corresponding data 212. In addition, each member may be a potential node. Hierarchy display 200 includes each member's individual information, as well as information for each parent member (i.e., node member). Accordingly, each node is identified by a number (e.g., 1, 1.2, 1.2.3, and 1.3) and each member is identified by a number (e.g., 1.1, 1.2.1, 1.2.2, 1.2.3.1, 1.2.3.2, 1.3.1, and 1.3.2). As indicated, each node identifier 214 takes the name of the first member of a branch, which is the parent. Therefore, node number 1 represents Alliance Group, which is a parent to node number 1.2 (“Apex Systems”), and node number 1.3 (“Sarah Outdoor”). In addition, node number 1.2 represents Apex Systems, which is the parent to member number 1.2.2 (“Easy Solutions”) and member number 1.2.3 (“Central Association”).

A numbering or equivalent system (e.g., bullets) may assist in the readability of the hierarchy. The numbering system provides a means by which a user may be able to determine a position of a particular member or a set of members within the hierarchy, as well as its relationship with other members of the hierarchy.

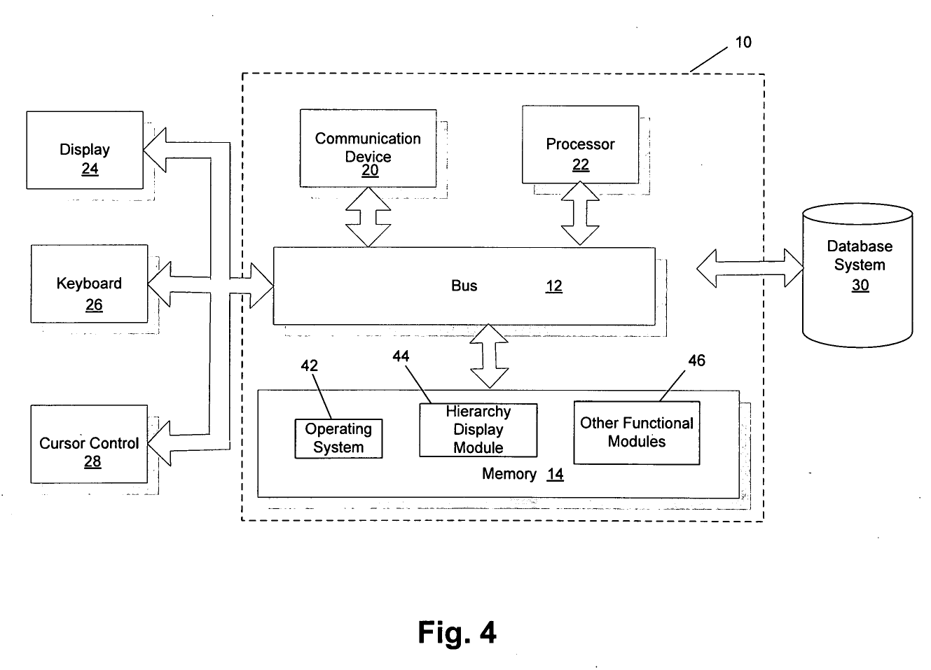

FIG. 4 is a block diagram of a system 10 that can implement one embodiment. System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, to provide access to a network. Therefore, a user may interface with system 10 directly, or remotely through a network or any other method.

Computer readable media may be any available media that can be accessed by processor 22 and includes both volatile and nonvolatile media, removable and non-removable media, and communication media. Communication media may include computer readable instructions, data structures, program modules or other data in a modulated data signal such as a carrier wave or other transport mechanism and includes any information delivery media.

Processor 22 is further coupled via bus 12 to a display 24, such as a Liquid Crystal Display (“LCD”), for displaying information to a user. A keyboard 26 and a cursor control device 28, such as a computer mouse, is further coupled to bus 12 to enable a user to interface with system 10.

In one embodiment, memory 14 stores software modules that provide functionality when executed by processor 22. Modules include an operating system 42 that provides operating system functionality for system 10. Modules further include a hierarchy display module 44, which configures a hierarchy display based on a number of determinations, as disclosed in more detail below. Modules may include other functional modules 46. For example, functional modules 46 may include PeopleSoft Enterprise Financial Management System. In other embodiments, hierarchy display module 44 may be a stand-alone system, or may be part of any other system.

Database system 30 may include a database server and any type of database, such as a relational or flat file database. Database system 30 may store data set 100 and/or any data associated with the system 10 or its associated modules.

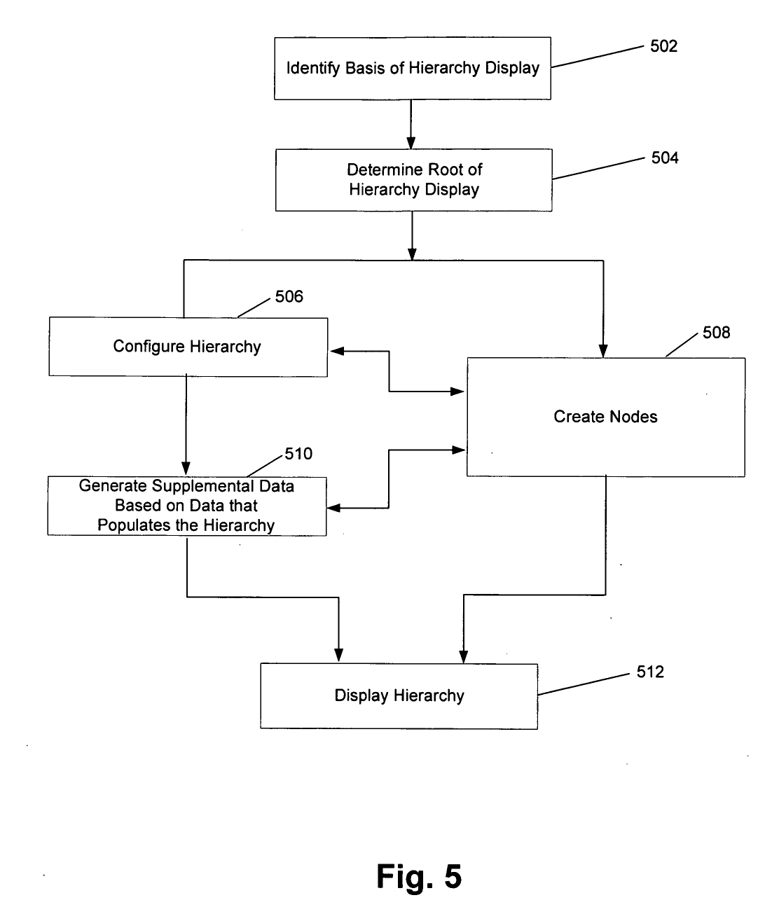

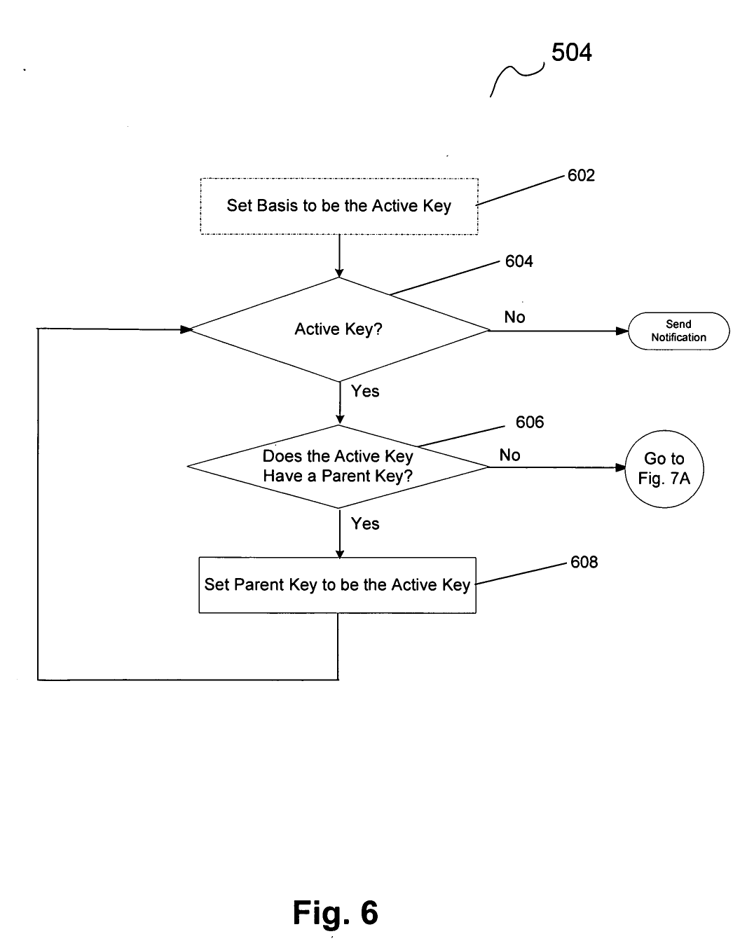

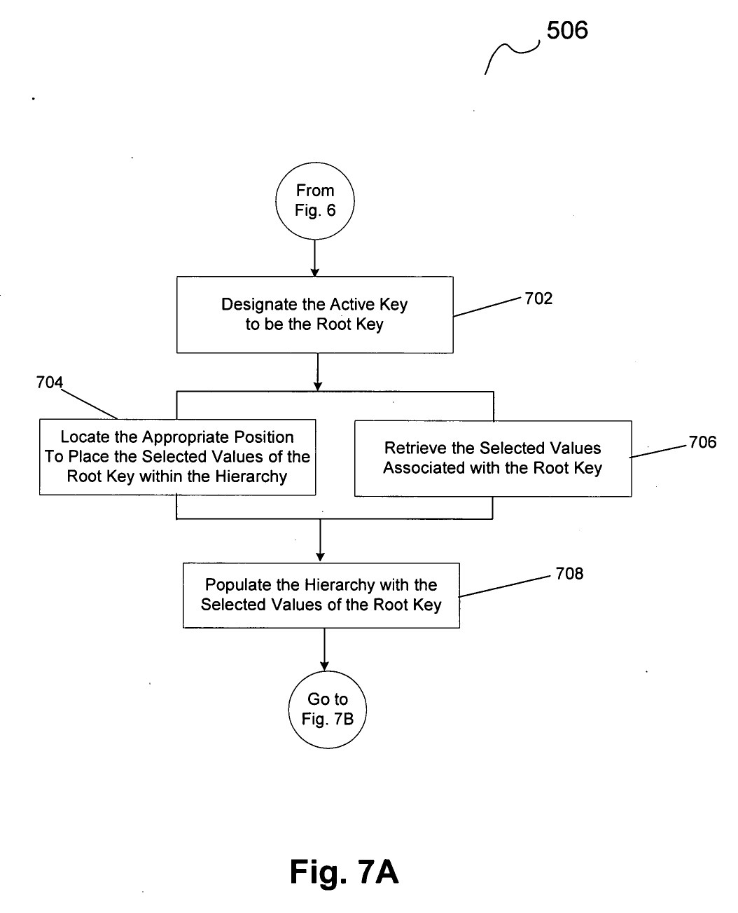

FIG. 5 is a flow diagram illustrating a process associated with creating a hierarchy display 200 in accordance with one embodiment. In one embodiment, the functionality of the flow diagram of FIG. 5, and FIGS. 6-8 below, is implemented by software stored in memory or other computer readable or tangible media, and executed by a processor. In other embodiments, the functionality can be performed by hardware (e.g., through the use of an application specific integrated circuit (“ASIC”), a programmable gate array (“PGA”), a field programmable gate array (“FGPA”), etc.), or any combination of hardware and software.

At 502, a basis for the hierarchy display is identified. The basis serves as a foundation or an area of focus for the hierarchy. A user may select a particular member to be a focus for the hierarchy display 200. Hierarchy display module 44 will generate a hierarchy for that particular member. FIG. 2 displays a hierarchy, in which an entity selected Alliance Group (e.g., identified by the key “SHARE 1000”) to be the focus of the hierarchy display 200 via search tool 220.

At 504, once the basis for the hierarchy display 200 has been identified, the root of the hierarchy basis is determined. FIG. 6 illustrates a method of determining a root member of a hierarchy in accordance with one embodiment.

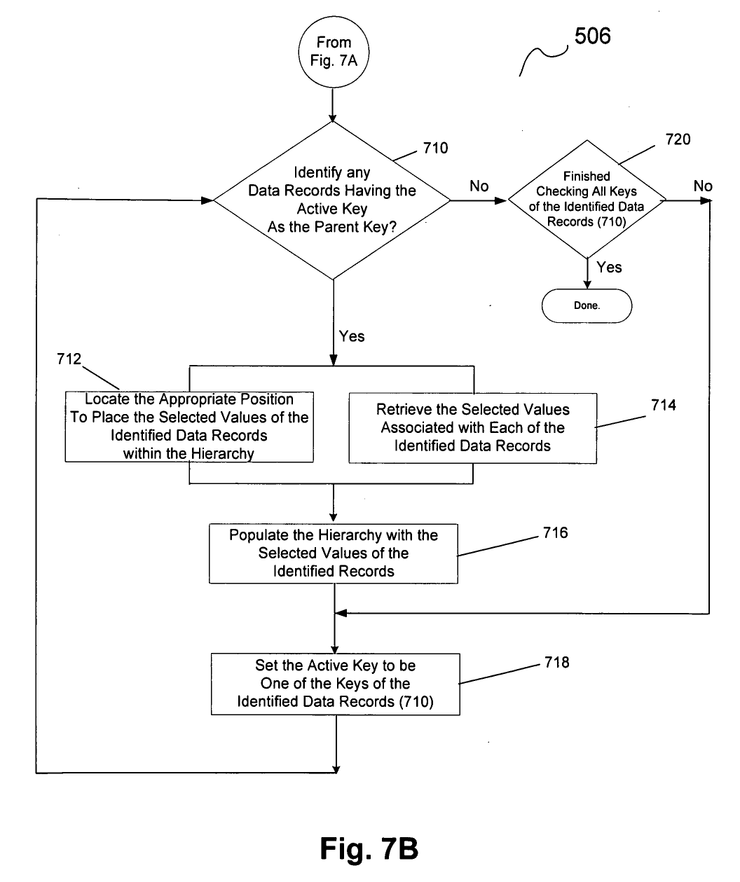

At 506, a hierarchy is configured. FIGS. 7A and 7B illustrate a method of configuring a hierarchy in accordance with one embodiment.

At 508, nodes are formed by logically grouping certain hierarchy members and their associated data. As illustrated in FIG. 5, nodes may be created at any time during the establishment of hierarchy display 200. For example, nodes may be created while configuring the hierarchy or after configuring the hierarchy. As another option, nodes may be created after the hierarchy is populated with supplemental data.

At 510, supplemental data is generated based on data that is selected from data set 100 to populate the hierarchy. For example, a component of the hierarchy may be analyzed. In addition, a number of operations may be performed on the data of the hierarchy component to generate the desired supplemental data. In FIG. 2, selected values, associated with a branch of each node, are analyzed. A sum of each branch is computed for the “Item Balance” and “Past Due” fields. In this case, the desired supplemental data, which is generated for hierarchy display 200, is the sum of a branch of each field. Each sum is generated, and displayed in node summary 216.

At 512, the hierarchy is displayed. FIG. 2 illustrates an example of a hierarchy display 200, which is configured with Alliance Group, as the basis. Hierarchy display 200 is configured from data retrieved from data set 100 in addition to supplemental data, which includes the numbering system and the node summary values. Hierarchy display 200 is also configured with nodes, which represent each parent member of the hierarchy.

FIG. 6 is a flow diagram illustrating a method of identifying a root of a data set in accordance with one embodiment.

At 602, the key, associated with the hierarchy basis, is set as the active key. In general, an active key refers to a key within a data set that is currently being considered and/or evaluated.

At 604, the presence of an active key is checked. The presence of an active key indicates that the active key has been set. If it is determined that an active key is not present or has not been set, the process comes to an end, or an error notification is sent. If an active key exists, then the process proceeds to 606.

At 606, it is determined if the active key is the root key. The functionality is able to ascertain if the active key is the root key by determining if the active key has a parent key.

If the active key does not have a parent key, then the active key is considered to be the root key, and the process proceeds to FIG. 7A. There are a number of ways in which the relationship key of data set 100 may indicate that an entity in data set 100 is a root. For example, if the relationship key of the examined data record is substantially similar to the key of the examined data record, then the data record being examined is the root. In this case, the root is the data record in which the active key and the parent key contain the same value. In FIGS. 1-2, Alliance Group is determined to be the root of the hierarchy display because its relationship key (i.e., parent key 104) is “SHARE 1000,” which is the same value as its own key 102 (i.e., “SHARE 1000”).

Another way of indicating that the active key lacks a parent key (i.e., active key=root key) is by setting the relationship key of the parent to a predetermined value. In this case, the active key is determined to be the root key upon discovering that the relationship key contains the predetermined value.

If the active key has a valid parent key, then the active key is not considered to be the root key, and proceeds to 608. A parent key 104 is deemed to be valid if it identifies a key 102 of another data record in data set 100.

At 608, the parent key, identified at 606, is set as the active key. The newly set active key is evaluated to determine if it is the root key. This process of evaluating keys continues until a root key is found, a notification (e.g., error notification) is sent, or the process terminates.

Referring to FIG. 6 while using FIGS. 1-2 as an example, the key, “SHARE 1000,” is selected to be the initial active key because it uniquely identifies Alliance Group, which has been selected to be the basis of hierarchy display 200 via search tool 220. Since an active key (i.e., “SHARE 1000”) exists for Alliance Group (604), it is determined if “SHARE 1000” of Alliance Group has a parent key 104 (606). Alliance Group does not have a parent key. Instead, the relationship key (e.g., Corporate SetID and Corporate ID) for Alliance Group contains “SHARE 1000,” which is the same value as Alliance Group's own key. Alliance Group (i.e., key SHARE 1000) is thus identified to be the root of the hierarchy display 200.

Since FIG. 6 determines the root of the hierarchy based on the hierarchy basis, it is recognized that if any of the other members in hierarchy display 200 were selected as the hierarchy basis, then the same root (i.e., “Alliance Group”) would have been discovered via this recursive process. In addition, the same hierarchy would be displayed, but a different hierarchy basis would be color coded or highlighted in hierarchy display 200.

For example, if Sara Outdoor (SHARE 1006) was selected as the hierarchy basis, then the functionality would determine that Sara Outdoor has a parent key of Alliance Group (SHARE 1000). SHARE 1000 (Alliance Group) would be set as the new active key. Then, the functionality would determine that Alliance Group does not have a parent key but contains a relationship key 104 that is the same value as its own key. Accordingly, in this example, Alliance Group (i.e., key SHARE 1000) is identified as the root via the recursive process, shown in FIG. 6.

FIGS. 7A and 7B are flow diagrams illustrating a method of configuring a hierarchy in accordance with one embodiment. FIG. 7A illustrates a method of populating the hierarchy with selected values of the root key in accordance with one embodiment. FIG. 7B illustrates a method of determining other members of the hierarchy and populating the hierarchy with selected values, associated with the other members of the hierarchy.

At 702, once the current active key is determined to be the root key (606), the active key designates, indirectly or directly, this key be the root key.

At 704, the functionality locates the appropriate position to place the selected values, associated with the root key, within the hierarchy. In general, data, associated with the root key, is located at or near the top of the hierarchy display 200.

At 706, the values, which are selected to populate the hierarchy, are accessed and retrieved from data set 100. The values are associated with the root key.

As illustrated in FIG. 7A, once the root key has been determined (702), then 704 and 706 may be performed simultaneously, or in any conceivable order.

At 708, the hierarchy is populated with selected values, associated with the root key. As illustrated in FIG. 2, the selected values may include an identifier 210 and corresponding data 212. The selected values may be retrieved from data set 100.

At 710, it is determined if the active key has any children. In making this determination, the relationship fields of the parent key 104 within data set 100 may be searched. If any of the parent keys 104 within data set 100 contain the same value as the current active key, then these data records are identified and their corresponding keys 102 are returned to the system.

If it is determined that there is at least one data record that has the newly set active key as a parent key, then the process proceeds to 712 and/or 714. If it is determined that there are no data records that have a parent key 104, which is the same value as the current active key, then the process proceeds to 720.

In the example shown in FIGS. 1-2, since the first active key (SHARE 1000) was discovered to be the root key, then each data record that has “SHARE 1000” set as the relationship key, (e.g., Corporate SetID and Corporate ID) is identified. In this case, it is determined that the active key (SHARE 1000) of Alliance Group has two children, Apex Systems and Sarah Outdoor, because they both contain “SHARE 1000” for parent key 104, as indicated by Corporate SetID and Corporate ID.

At 712, the functionality locates the appropriate position to place the data, which will populate the hierarchy display 200. As illustrated in FIG. 2, once the selected values associated with the root key have been placed at the top of the hierarchy, then each subsequent entry of selected values is placed in a row below the row that was previously populated.

As shown in section 206, hierarchy display 200 may contain a preset spacing or indentation between different levels of the hierarchy. The spacing may provide a visual representation of the level at which a particular item belongs in the hierarchy. For example, the identifiers of children may have a greater indentation from the left margin than the identifiers of parents. Identifiers that are aligned are considered to be in the same hierarchy level. Aligned identifiers, which belong to the same parent, may be considered to be siblings.

Meanwhile, as shown in section 208, hierarchy display 200 may contain data in which the selected values are aligned into columns. Each column of data represents a data field, such as Item Balance, Past Due, or Credit Limit.

At 714, data set 100 is accessed, and the values, which have been selected to populate the hierarchy, are retrieved. Information is retrieved for each and every data record that is identified as a child of the active key (710). This information may include an identifier 210 and corresponding data 212.

Referring to FIGS. 1-2 as an example, the hierarchy includes values, which have been accessed and retrieved from data set 100. In this case, the Customer ID and the Customer are retrieved from data set 100 to serve as the identifier 210 for the hierarchy. Data 212 includes the Item Balance, the Past Due Balance, and the Credit Limit, which are retrieved from data set 100 to populate the hierarchy.

At 716, the hierarchy is populated with all children members, associated with the active key. The hierarchy includes each child member's information such as the values that have been selected to populate the hierarchy and retrieved at 714.

At 718, one of the keys of the data records, identified at 710, is set to be the active key. By performing this operation, it is determined if any of the children are also parents. In other words, it is determined if any of the identified data records (710) have children. In each case in which a new active key is set, the flow diagram recursively iterates through 710, 712, 714, 716, and 718 until all members of the hierarchy are identified from data set 100, and populate the hierarchy.

At 720, after determining that the current active key (710) is not listed as a parent key 104 within data set 100, then the functionality determines if all of the keys 102, which have been identified at 710 have been checked for children. If there is at least one key, associated with a data record identified at 710, which has not been checked, then the process proceeds to 718 to set the next identified key 102 to be the active key in accordance with the recursive process. If it is determined that all of the keys 102 associated with data records, which were identified at 710, have been checked, then the recursive process of configuring a hierarchy comes to an end.

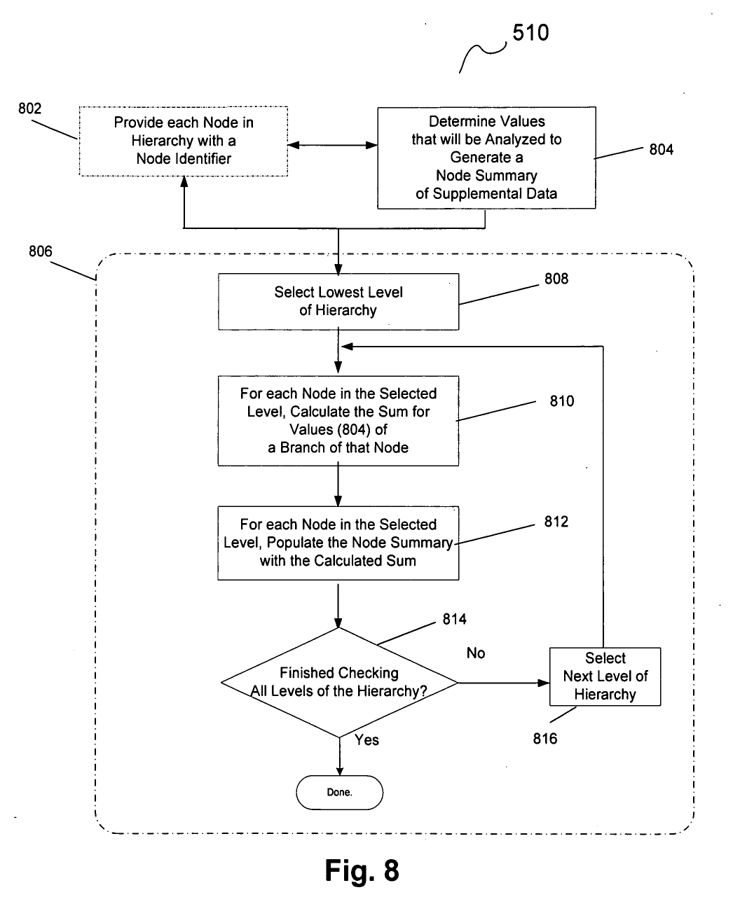

FIG. 8 is a flow diagram illustrating a method of generating supplemental data for hierarchy display 200, as illustrated in FIG. 2, in accordance with one embodiment.

At 802, each node is provided with a node identifier 210. If desired, each node may be provided with other supplemental data, such as an assigned number accordance with a hierarchy-numbering scheme. In this embodiment, step 802 is being performed at step 510 of FIG. 5. However, as denoted in FIG. 8 by the dotted line, step 802 may be performed at any time during the process of establishing a hierarchy display. For example, in alternative embodiments, step 802 may be performed at 506 or 508.

At 804, the fields, which will be involved in generating a node summary comprising supplemental data, are identified. In the example shown in FIG. 2, it is determined that supplemental data will be generated for node summary values, corresponding to “Item Balance” and “Past Due.” Due to the nature of credit limit values, hierarchy display 200 will not include a node summary value for the “Credit Limit” field.

At 806, the supplemental data that will populate the node summary values are generated. In one embodiment, calculated totals of data 212 are rolled up, as discussed in steps 808, 810, 812, 814, and 816.

At 808, the lowest level of the hierarchy is selected. In FIG. 2, the level, associated with number 1.2.3 of the numbering scheme, is identified as the lowest level. Level 1.2.3, which includes “Central Association” (identified by number 1.2.3.1) and “Golden Inc” (identified by number 1.2.3.2), is thus selected.

At 810, for each node in the selected level, the sum is calculated for a branch of each selected field of that node. In FIG. 2, the lowest level includes a single node, identified by 1.2.3. This node has a branch, which includes “Central Association” and “Golden Inc.” Node summary 216 is populated with an Item Balance and a Past Due. The node summary value for the Item Balance is $984.00, which is the calculated sum of the Item Balance of Central Association ($0.00) and the Item Balance for Golden Inc. ($984.00). The node summary value for the Past Due is $984.00, which is the calculated sum of the Past Due for Central Association ($0.00) and the Past Due for Golden Inc. ($984.00).

At 812, for each node in the selected level, the node summary values are populated with the sum values, which were calculated at 810.

In FIG. 2, the node summary 216 of the Central Association node, identified by 1.2.3, is populated with an Item Balance value of $984.00, and a Past Due Balance value of $984, as discussed above.

At 814, it is determined if the process has finished checking all levels, which are contained in the hierarchy. If all of the levels of the hierarchy and each node (including the root node) have been checked, then the process is done. If each level of the hierarchy has not been checked, then the process proceeds to step 816.

In FIG. 2, upon populating the node summary values for level 1.2.3, the functionality determines that it has not finished checking all levels of the hierarchy. In this case, the process proceeds to 816.

At 816, the next level of the hierarchy is selected. As illustrated in FIG. 8, the process, shown as 806, continues until all levels of the hierarchy have been checked, and each node includes a node summary.

In FIG. 2, after populating the hierarchy with the node summary values for level 1.2.3, the next level of the hierarchy is selected. The next level of the hierarchy includes nodes 1.2 and 1.3. The process then proceeds to 810. In this case, a sum is calculated for node 1.2 and node 1.3, respectively.

Referring to node 1.2 (“Apex Systems”), the node summary value for the Item Balance field is $2,085,272.57, which is the calculated sum of the Past Due for Apex Systems ($1,470,203.93), Easy Solutions ($614,084.64) and Central Association ($984.00). The node summary value for the Past Due field is $2,085,272.57, which is the calculated sum of the Past Due for Apex Systems ($1,470,203.93), Easy Solutions ($614,084.64) and Central Association ($984.00). In this example, the node summary value for Central Association is used in calculating the total for the Apex Systems node.

Referring to node 1.3 (“Sara Outdoor”), the node summary value for the Item Balance field is $22,504.33, which is the calculated sum of the Item Balance for Sara Outdoor ($0.00) and Surplus Co. ($22,504.33). The node summary value for the Past Due is $22,504.33, which is the calculated sum of the Past Due for Sara Outdoor ($0.00) and Surplus Co. ($22,504.33).

Once the node summary values for Apex Systems and Sara Outdoor populate the hierarchy, the process proceeds to 814 and 816, where it is determined that the next level contains a single node, assigned the number 1 in the numbering scheme and referred to as “Alliance Group.” With respect to the Alliance Group node, the node summary value for the Item Balance field is $3,300,281.33, which is the calculated sum of the Item Balance for Alliance Group ($1,192,504.43), Apex Systems ($2,085,272.57), and Sara Outdoor ($22,504.33). The node summary value for the Past Due is $3,300,281.33, which is the calculated sum of the Past Due for Alliance Group ($1,192,504.43), Apex Systems ($2,085,272.57), and Sara Outdoor ($22,504.33). Upon populating the hierarchy with these node summary values, the process of generating supplemental data comes to an end since all of the levels of the hierarchy have been checked and all of the nodes include the appropriate node summary values.

As shown in FIG. 2, hierarchy display 200 provides full visibility into the aggregate Item Balance, Past Due Balance, and Credit Limit for each level of the corporate hierarchy. Hierarchy display 200 is also configured to show the Item Balance, Past Due Balance, and Credit Limit for each individual hierarchy member. Such a configuration allows an entity to view the aggregate values for each level, as well as the individual values for each hierarchy member on a single hierarchy display 200 without having to navigate to different displays, pages, or work areas. These features provide entities with the ability to make well-informed decisions at a quick rate, which may lead to improved cash flow, lower Days Sales Outstanding (DSO), improved relations with large customers, and improved efficiencies in their collections process.

As discussed above, a hierarchy display represents a data set containing multi-level relationships in an organized manner. The system graphically represents the relationships between members of the hierarchy in a manner that allows a user to visualize the multi-level relationships with speed and ease.

The system may represent the multi-level relationships in an H-Grid format. The H-Grid format is particularly efficient in providing a graphical representation of the multi-level relationships without consuming a significant amount of display space.

The system selectively populates a section of the H-Grid with identifiers. The identifiers identify a member of a hierarchy and/or identify a data record. The identifiers are positioned to denote members' positions within the hierarchy. The system associates a number of corresponding data with the identifiers. This association enables a user to determine a hierarchical position or relationship of corresponding data with relative ease and speed.

Since the corresponding data are associated with identifiers, which denote hierarchical positioning, the system is able to populate these corresponding data values in a format that is suitable and appropriate for the information that it contains. For example, if the corresponding data are numerical values, then the numerical values of various data records may be aligned in a particular manner (e.g., column) that facilitates the understanding of any mathematical relationships and/or calculations that may exist between or among the numerical values in the hierarchy.

Several embodiments are specifically illustrated and/or described herein. However, it will be appreciated that modifications and variations of the disclosed embodiments are covered by the above teachings and within the purview of the appended claims without departing from the spirit and intended scope of the invention.

What is claimed is:

1. A computer readable media having instructions stored thereon that, when executed by a processor, causes the processor to:
identify a basis for a hierarchy;
determine a root of a data set using the basis;
configure the hierarchy beginning at the root;
populate the hierarchy with selected values from the data set;
generate supplemental data based on the selected values;
embed the supplemental data within the populated hierarchy; and
display the hierarchy.

2. The computer readable media of claim 1, wherein the determination of the root comprises:
setting a key of the basis to be an active key;
determining if the active key has a parent;
designating the active key to be the root if the active key does not have a parent key; and
setting the parent key to be the active key if the active key has a parent.

3. The computer readable media of claim 1, wherein the selected values from the data set comprise:
an identifier to identify a member of the hierarchy; and
corresponding data associated with the identifier.

4. The computer readable media of claim 3, wherein the population of the hierarchy comprises:
populating the hierarchy with selected values for the root;
identifying data records that have the active key as the parent key;
populating the hierarchy with selected values for the identified data records;
setting the active key to be one of the keys of the identified data records; and
recursively determining if any data records of the data set have the active key as the parent key until all of the members of the hierarchy and their selected values populate the hierarchy.

5. The computer readable media of claim 1, further comprising instructions that cause the processor to:
create a node for each member of the hierarchy that is a parent, wherein each node comprises:
at least one member and corresponding data of the at least one member;
a node identifier to identify the node; and
a node summary to summarize the corresponding data of the node.

6. The computer readable media of claim 5, wherein the generation of supplemental data comprises:
generating a node identifier for each node;
generating a node summary for each node; and
assigning a number to each member based on a numbering scheme that designates a hierarchical position of the member.

7. The computer readable media of claim 6, wherein the generation of the node summary for the lowest level of the hierarchy comprises:
selecting a lowest level of the hierarchy;
for each node in the lowest level, calculating a sum for a branch of corresponding values within a first field;
for each node in the lowest level, calculating a sum for a branch of corresponding values within a second field; and
for each node in the lowest level, populating the node summary with the sum of the first field and the sum of the second field.

8. The computer readable media of claim 7, wherein the generation of the node summary for the next level of the hierarchy comprises:
selecting a next level of the hierarchy, the next level being one level above the lowest level;
for each node in the next level, calculating a sum for a branch of corresponding values within the first field;
for each node in the next level, calculating a sum for a branch of corresponding values within the second field; and
for each node in the next level, populating the node summary with the sum of the first field and the sum of the second field.

9. A hierarchy display system comprising:
a search tool to receive a hierarchy basis;
a data set that includes members of a hierarchy;
a processor enabled to establish a hierarchy display based in part on the hierarchy basis and the data set, the hierarchy display comprising:
a set of members, each member including an identifier to identify the member and corresponding financial data of the member; and
a node for each member of a hierarchy that is considered a parent, each node includes a node identifier to identify a node and a node summary to summarize the corresponding financial data of the node.

10. The hierarchy display system of claim 9, wherein the corresponding financial data includes an item balance, a past due balance, and a credit limit.

11. The hierarchy display system of claim 9, wherein the node summary includes a calculated sum of each item balance of every member of the node, a calculated sum of each past due balance of every member of the node, and a credit limit field.

12. The hierarchy display system of claim 9, wherein the node identifier is the first named member of the node.

13. The hierarchy display system of claim 9, wherein the identifiers are indented to denote hierarchy position, and the corresponding financial data are numerical values that are aligned in columns.

14. A computer implemented method for establishing a hierarchy display, the method comprising:
identifying a root key within a data set;
setting the root key to be the active key;
populating a hierarchy with an identifier and financial data of the root key;
identifying all data records in the data set that has the active key as a parent key;
populating the hierarchy with an identifier and financial data for each identified data record;
setting the active key to be one of the keys of the identified data records;
recursively iterating through the steps of identifying all data records, populating the hierarchy, and setting the active key until all hierarchy members from the data set populate the hierarchy;
creating a node for each member of a hierarchy that is considered a parent, each node includes a node identifier to identify a node and a node summary to summarize the corresponding financial data of the node; and
displaying the populated hierarchy on a single display screen.

15. The computer implemented method of claim 14, wherein the financial data of the root key and the financial data for the identified data records include an item balance, a past due balance, and a credit limit.

16. The computer implemented method of claim 14, wherein the node summary includes a calculated sum of each item balance of every member of the node, a calculated sum of each past due balance of every member of the node, and a credit limit field.

17. A system for establishing a hierarchy display, the system comprising:
means for identifying a basis for a hierarchy;
means for determining a root of a data set using the basis;
means for configuring the hierarchy beginning at the root;
means for populating the hierarchy with selected values from the data set, the selected values include an identifier to identify a member of the hierarchy and corresponding financial data;
means for generating supplemental data based on the corresponding financial data;
means for embedding the supplemental data within the populated hierarchy; and
means for displaying the hierarchy.

18. The system of claim 17, further comprising:
means for creating a node for each member of the hierarchy that is a parent, wherein each node comprises:
at least one member and corresponding financial data of the at least one member;
a node identifier to identify the node; and
a node summary that includes the supplemental data, the supplemental data summarizing the corresponding financial data.
